(19) United States
(12) Patent Application Publication
(10) Pub. No.: US 2021/0388994 A1
(43) Pub. Date: Dec. 16, 2021

(54) RETRACTABLE COVER APPARATUS AND RANGE HOOD

(71) Applicant: Joshua Seifert, Eagle Mountain, UT (US)

(72) Inventor: Joshua Seifert, Eagle Mountain, UT (US)

(21) Appl. No.: 16/903,086

(22) Filed: Jun. 16, 2020

(51) Int. Cl. F24C 15/20

(52) U.S. Cl. CPC F24C 15/2092; H05B 6/6423; F24C 15/2042

(57) ABSTRACT

A cover apparatus operable to at least partially cover an appliance is disclosed. The cover apparatus may include a front side, a left side coupled to the front side, and a right side coupled to the front side. The front side, the left side, and the right side may at least partially form an enclosure. The cover apparatus may also include one or more actuators operable to be mounted to a fixture situated above the appliance. The one or more actuators may be coupled to an underneath surface of the front side via one or more connectors that extend between the one or more actuators and the underneath surface of the front side. The cover apparatus may be operable to move between an open position and a closed position. The appliance may at least partially occupy the enclosure when the cover apparatus is in the closed position.

### BACKGROUND OF THE INVENTION

A microwave oven, or simply a “microwave”, is an electric oven that heats items by producing electromagnetic radiation in the microwave frequency range. Microwave ovens are a widely-used kitchen appliance and are generally used for cooking or reheating a variety of foods. The first commercial microwave oven, which became available in 1947, was large and bulky. Since then, various improvements to the size and performance of microwave ovens have been developed. For example, microwave ovens that are mounted above a range have become common. Such microwave ovens are referred to as over-the-range microwaves. For a variety of reasons, it can be advantageous to cover such over-the-range microwaves both during use and while not in use.

### SUMMARY OF THE INVENTION

A summary of the invention is provided below as a list of example. As used below, any reference to a series of examples is to be understood as a reference to each of those examples disjunctively (e.g., “Examples 1-4” is to be understood as “Examples 1, 2, 3, or 4”).

Example 1 is a cover apparatus operable to at least partially cover an appliance, the cover apparatus comprising: a front side; a left side coupled to the front side; a right side coupled to the front side, wherein the front side, the left side, and the right side at least partially form an enclosure; and one or more actuators operable to be mounted to a fixture situated above the appliance, wherein the one or more actuators are coupled to an underneath surface of the front side via one or more connectors that extend between the one or more actuators and the underneath surface of the front side; wherein the cover apparatus is operable to move between an open position and a closed position, and wherein the appliance at least partially occupies the enclosure when the cover apparatus is in the closed position.

Example 2 is the cover apparatus of example(s) 1, further comprising: a left pivot member coupled to a left surface of the fixture and to the left side; and a right pivot member coupled to a right surface of the fixture and to the right side.

Example 3 is the cover apparatus of example(s) 2, wherein the left pivot member and the right pivot member form a pivot point for moving the cover apparatus.

Example 4 is the cover apparatus of example(s) 1, wherein the one or more actuators include a left actuator and a right actuator.

Example 5 is the cover apparatus of example(s) 1, wherein the one or more actuators are electrically powered and are operable to produce mechanical movement of the one or more connectors causing the cover apparatus to move between the open position and the closed position.

Example 6 is the cover apparatus of example(s) 1, wherein the appliance is accessible when the cover apparatus is in the open position.

Example 7 is the cover apparatus of example(s) 1, wherein the left side is at least partially parallel to the right side.

Example 8 is the cover apparatus of example(s) 7, wherein the front side is at least partially perpendicular to each of the left side and the front side.

Example 9 is the cover apparatus of example(s) 1, wherein the appliance is a microwave oven.

Example 10 is an apparatus operable to at least partially cover an appliance, the apparatus comprising: a fixture having a front surface and a bottom surface, wherein the fixture is operable to be situated above the appliance, and wherein the bottom surface is operable to be coupled to the appliance; and a cover apparatus comprising: a front side; a left side coupled to the front side; a right side coupled to the front side, wherein the front side, the left side, and the right side at least partially form an enclosure; and one or more actuators operable to be mounted to the fixture, wherein the one or more actuators are coupled to an underneath surface of the front side via one or more connectors that extend between the one or more actuators and the underneath surface of the front side; wherein the cover apparatus is operable to move between an open position and a closed position, and wherein the appliance at least partially occupies the enclosure when the cover apparatus is in the closed position.

Example 11 is the apparatus of example(s) 10, wherein the cover apparatus further comprises: a left pivot member coupled to a left surface of the fixture and to the left side; and a right pivot member coupled to a right surface of the fixture and to the right side.

Example 12 is the cover apparatus of example(s) 11, wherein the left pivot member and the right pivot member form a pivot point for moving the cover apparatus.

Example 13 is the cover apparatus of example(s) 10, wherein the one or more actuators include a left actuator and a right actuator.

Example 14 is the cover apparatus of example(s) 10, wherein the one or more actuators are electrically powered and are operable to produce mechanical movement of the one or more connectors causing the cover apparatus to move between the open position and the closed position.

Example 15 is the cover apparatus of example(s) 10, wherein the appliance is accessible when the cover apparatus is in the open position.

Example 16 is the cover apparatus of example(s) 10, wherein the left side is at least partially parallel to the right side.

Example 17 is the cover apparatus of example(s) 16, wherein the front side is at least partially perpendicular to each of the left side and the front side.

Example 18 is the cover apparatus of example(s) 10, wherein the appliance is a microwave oven.

### BRIEF DESCRIPTION OF THE DRAWINGS

FIG. 1 illustrates an example configuration of a cover apparatus.

FIG. 2 illustrates an example configuration of a cover apparatus.

FIGS. 3A-3E illustrate an example method of assembling a cover apparatus.

FIGS. 4A-4C illustrate example side views of a cover apparatus and a fixture.

FIG. 5 illustrates an example computer system.

### DETAILED DESCRIPTION OF SPECIFIC EMBODIMENTS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

Embodiments provided herein relate to a cover apparatus for partially covering an appliance or other object. The cover apparatus may further function as a faux range hood. For example, the cover apparatus can provide a solution for home builders, home renovators, and homeowners by providing a cover that has the look and feel of an expensive range hood while maintaining the location and functionality of their current microwave. In many cases, a home may have an over-the-range style microwave which limits their ability to have a desired look.

In some embodiments, the cover apparatus can be lifted or slide vertically to access the microwave. The cover apparatus can be electrically powered and can be controlled to move from a closed position to an open position, and then back from the open position to the closed position. In some embodiments, the cover apparatus uses the same power outlet that the microwave uses, which may be located in a storage cabinet situated above the microwave. The storage cabinet may include a door along the front surface of the storage cabinet that provides access to the power outlet. One advantage of the cover apparatus is that the vent fan and the light located at the bottom of the microwave are still accessible when the cover apparatus is in the closed position. In some embodiments, the cover apparatus may be manually moved without the use of electrical components. The cover apparatus can be made in many different styles, materials, sizes, and finishes to be customized to each customer's kitchen.

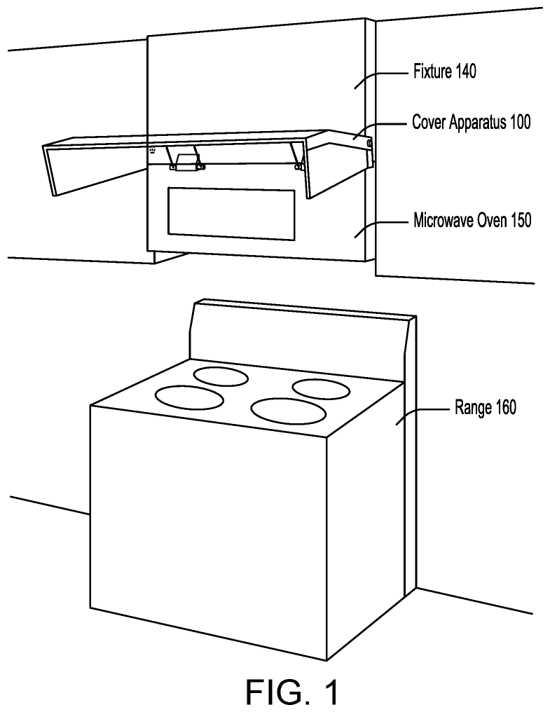

FIG. 1 illustrates an example configuration of a cover apparatus 100, according to some embodiments of the present disclosure. In the illustrated example, cover apparatus 100 is mechanically coupled to a fixture 140, which may be a cabinet, shelf, or other structure. Fixture 140 may be rigidly situated within a kitchen, in some examples. In some embodiments, a microwave oven 150 may be mounted to fixture 140 and situated vertically above a range 160 in an over-the-range configuration. In some embodiments, cover apparatus 100 may be partially mounted to microwave oven 150. In some embodiments, cover apparatus 100 may be mounted to both fixture 140 and microwave oven 150.

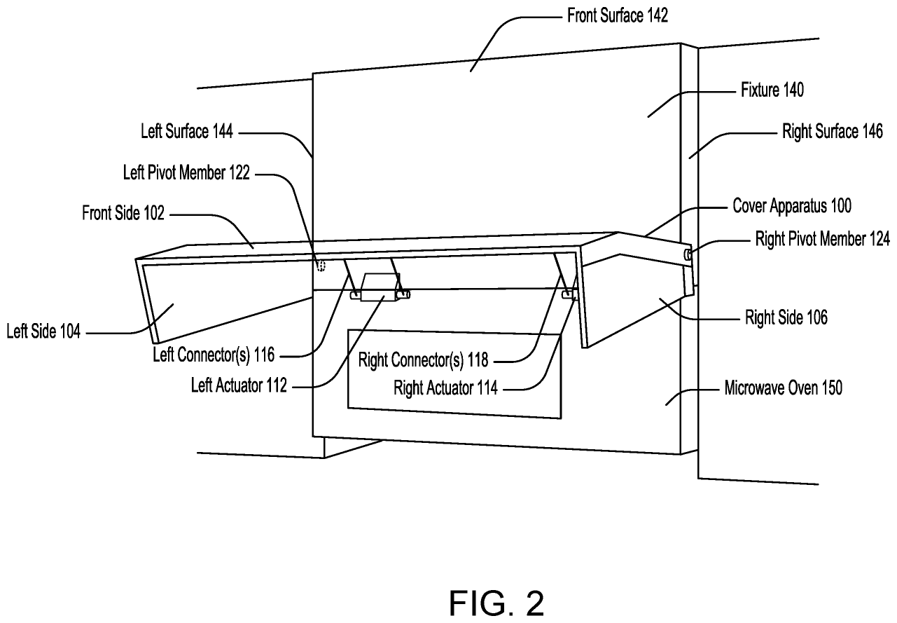

FIG. 2 illustrates an example configuration of cover apparatus 100, according to some embodiments of the present disclosure. In the illustrated example, cover apparatus 100 includes a front side 102, a left side 104, and a right side 106. In some embodiments, left side 104 may be coupled to front side 102 and right side 106 may also be coupled to front side 102. In some embodiments, left side 104 may be parallel to right side 106 and each of left side 104 and right side 106 may be perpendicular to front side 102.

Cover apparatus 100 may further include a left actuator 112 and a right actuator 114. Each of left actuator 112 and right actuator 114 may be coupled to a front surface 142 of fixture 140. In some embodiments, each of left actuator 112 and right actuator 114 may be coupled to microwave oven 150. In some embodiments, each of left actuator 112 and right actuator 114 may extend over a front surface of microwave oven 150. Each of left actuator 112 and right actuator 114 may be coupled to an underneath surface of front side 102 via one or more left connectors 116 and one or more right connectors 118, respectively. In some embodiments, each of left connectors 116 and right connectors 118 may have a variable length to accommodate for the variable distance between actuators 112 and 114 and the underneath surface of front side 102.

While FIG. 2 shows cover apparatus 100 in the open position, it should be understood that cover apparatus 100 may move between an open position and a closed position. While in the closed position, cover apparatus 100 may at least partially cover microwave oven 150. For example, cover apparatus 100 may cover the front surface of microwave oven 150 while leaving the bottom surface of microwave oven 150 accessible. Furthermore, while in the closed position, an enclosure formed by front side 102, left side 104, and right side 106 may be at least partially occupied by microwave oven 150.

In some embodiments, cover apparatus 100 may include a left pivot member 122 and a right pivot member 124. Left pivot member 122 may be coupled to left side 104 as well as a left surface 144 of fixture 140. Right pivot member 124 may be coupled to right side 106 as well as a right surface 146 of fixture 140. In some embodiments, left pivot member 122 and right pivot member 124 form a pivot point for moving cover apparatus 100. For example, left pivot member 122 and right pivot member 124 may form a joint or hinge about which cover apparatus 100 may rotate when being opened or closed.

In some embodiments, left actuator 112 and right actuator 114 are electrically powered to provide powered mechanical movement to cover apparatus 100. For example, each of left actuator 112 and right actuator 114 may include a rotary actuator or a linear actuator (e.g., a servomotor) that causes movement of left connectors 116 and right connectors 118. In some embodiments, a microcontroller with a communication interface may be utilized to send commands to left actuator 112 and right actuator 114. For example, a user may use a portable electronic device to send a wireless signal to a microcontroller associated with left actuator 112 and right actuator 114. Upon receiving the wireless signal, the microcontroller may cause left actuator 112 and right actuator 114 to move to cause movement of cover apparatus 100. In some embodiments, each of left actuator 112 and right actuator 114 may include a brushed permanent magnet direct current (DC) motor, a brushless motor, an alternating current (AC) induction motor, among other possibilities.

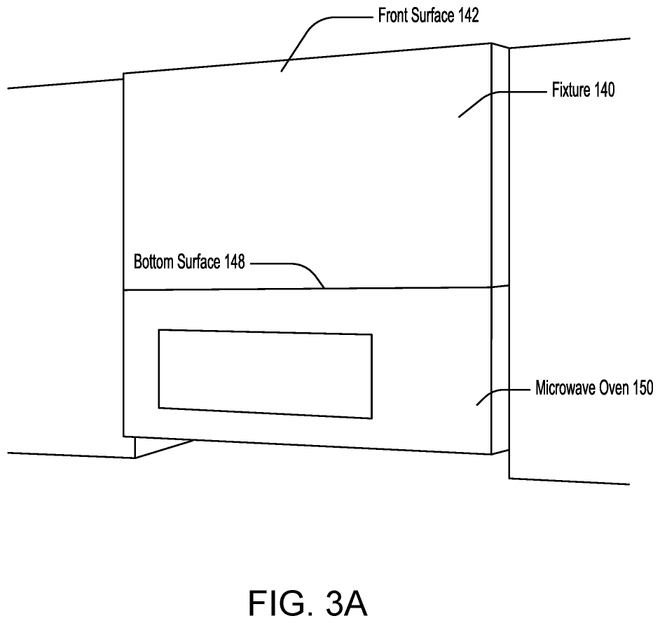

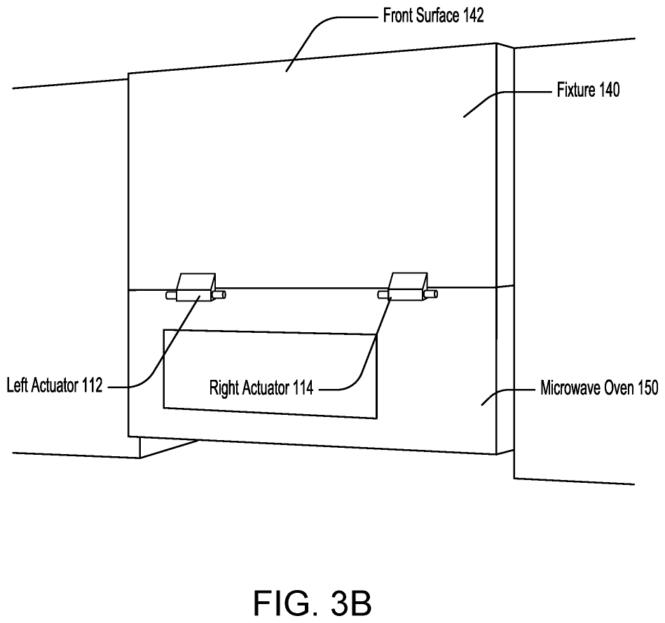

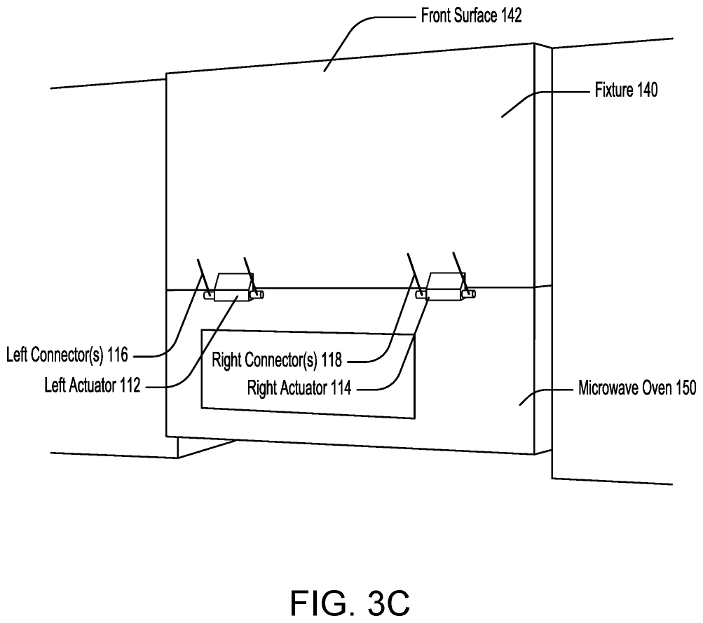

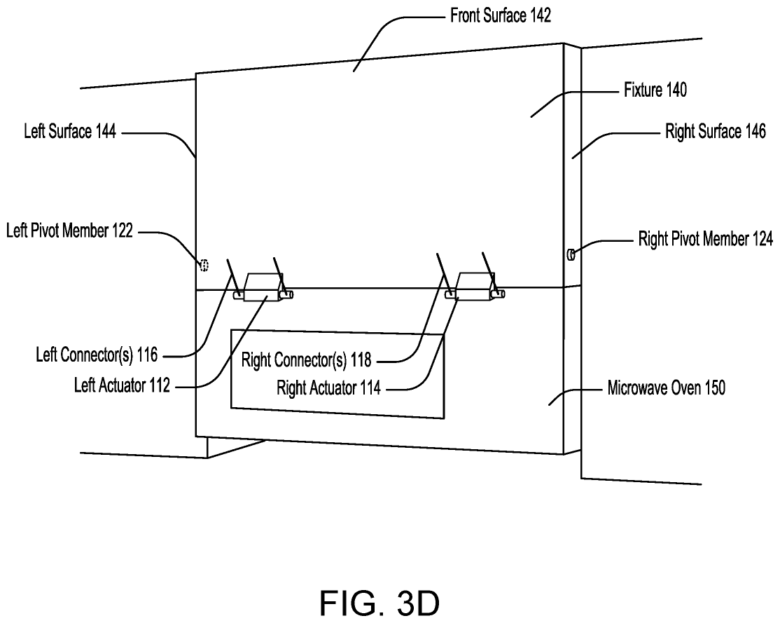

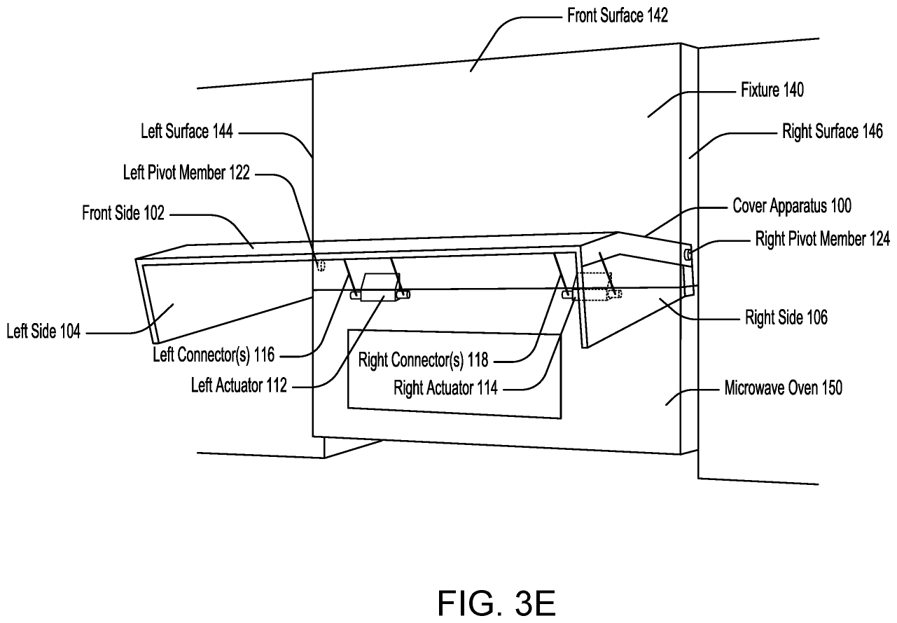

FIGS. 3A-3E illustrate an example method of assembling cover apparatus 100, according to some embodiments of the present disclosure. In reference to FIG. 3A, microwave oven 150 is mounted to a bottom surface 148 of fixture 140. In reference to FIG. 3B, left actuator 112 and right actuator 114 are mounted to front surface 142 of fixture 140. Optionally, left actuator 112 and right actuator 114 partially extend over the front surface of microwave oven 150. In reference to FIG. 3C, left connectors 116 and right connectors 118 are attached to left actuator 112 and right actuator 114, respectively. In reference to FIG. 3D, left pivot member 122 is optionally attached to left surface 144 and right pivot member 124 is optionally attached to right surface 146. In reference to FIG. 3E, front side 102, left side 104, and right side 106 of cover apparatus 100 are assembled together and attached to left connectors 116, right connectors 118, left pivot member 122, and/or right pivot member 124.

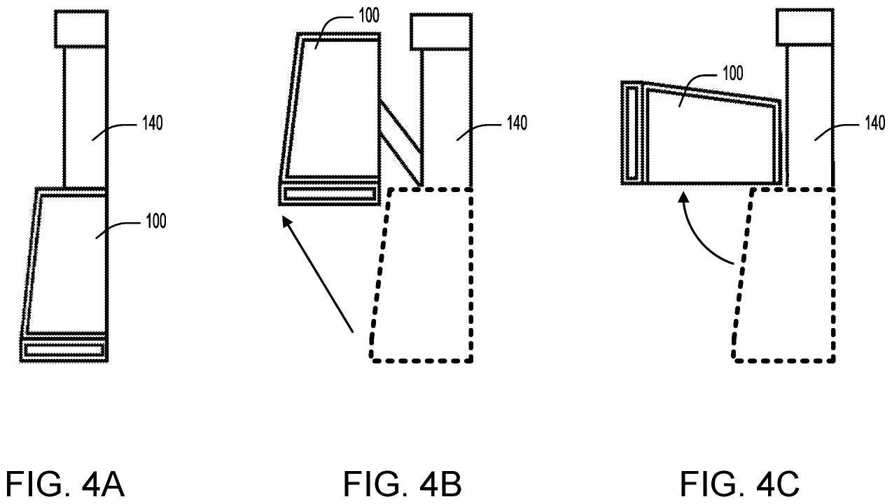

FIGS. 4A-4C illustrate example side views of cover apparatus 100 and fixture 140, according to some embodiments of the present disclosure. In reference to FIG. 4A, apparatus 100 is in the closed position. In reference to FIG. 4B, apparatus 100 is in the open position and is shown as extending vertically and laterally forward without rotation. In reference to FIG. 4C, apparatus 100 is in the open position and is shown as rotating upward in the vertical direction.

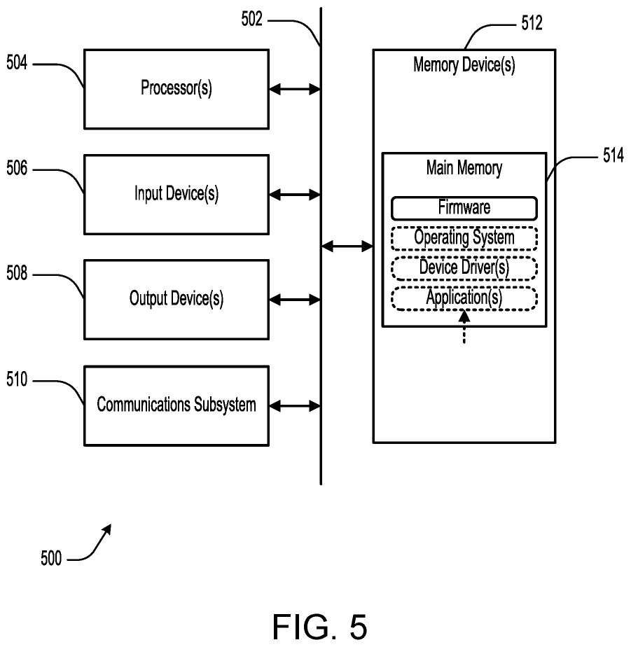

FIG. 5 illustrates an example computer system 500 comprising various hardware elements. Computer system 500 may be incorporated into or integrated with devices described herein and/or may be configured to perform some or all of the steps of the methods provided by various embodiments. For example, in various embodiments, computer system 500 may be incorporated into left actuator 112 and right actuator 114. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

In the illustrated example, computer system 500 includes a communication medium 502, one or more processor(s) 504, one or more input device(s) 506, one or more output device(s) 508, a communications subsystem 510, and one or more memory device(s) 512. Computer system 500 may be implemented using various hardware implementations and embedded system technologies. For example, one or more elements of computer system 500 may be implemented as a field-programmable gate array (FPGA), such as those commercially available by XILINX®, INTEL®, or LATTICE SEMICONDUCTOR®, a system-on-a-chip (SoC), an application-specific integrated circuit (ASIC), an application-specific standard product (ASSP), a microcontroller, and/or a hybrid device such as an SoC FPGA, among other possibilities.

The various hardware elements of computer system 500 may be coupled via communication medium 502. While communication medium 502 is illustrated as a single connection for purposes of clarity, it should be understood that communication medium 502 may include various numbers and types of communication media for transferring data between hardware elements. For example, communication medium 502 may include one or more wires (e.g., conductive traces, paths, or leads on a printed circuit board (PCB) or integrated circuit (IC), microstrips, striplines, coaxial cables, etc.), one or more optical waveguides (e.g., optical fibers, strip waveguides, etc.), one or more wireless connections (e.g., infrared wireless communication, radio communication, microwave wireless communication, etc.), among other possibilities.

In some embodiments, communication medium 502 may include one or more buses connecting pins of the hardware elements of computer system 500. For example, communication medium 502 may include a bus connecting processor(s) 504 with main memory 514, referred to as a system bus, and a bus connecting main memory 514 with input device(s) 506 or output device(s) 508, referred to as an expansion bus. The system bus may consist of several elements, including an address bus, a data bus, and a control bus. The address bus may carry a memory address from processor(s) 504 to the address bus circuitry associated with main memory 514 in order for the data bus to access and carry the data contained at the memory address back to processor(s) 504. The control bus may carry commands from processor(s) 504 and return status signals from main memory 514. Each bus may include multiple wires for carrying multiple bits of information and each bus may support serial or parallel transmission of data.

Processor(s) 504 may include one or more central processing units (CPUs), graphics processing units (GPUs), neural network processors or accelerators, digital signal processors (DSPs), and/or the like. A CPU may take the form of a microprocessor, which is fabricated on a single IC chip of metal-oxide-semiconductor field-effect transistor (MOSFET) construction. Processor(s) 504 may include one or more multi-core processors, in which each core may read and execute program instructions simultaneously with the other cores.

Input device(s) 506 may include one or more of various user input devices such as a mouse, a keyboard, a microphone, etc., as well as various sensor input devices, such as an image capture device, a pressure sensor (e.g., barometer, tactile sensor, etc.), a temperature sensor (e.g., thermometer, thermocouple, thermistor, etc.), a movement sensor (e.g., accelerometer, gyroscope, tilt sensor, etc.), a light sensor (e.g., photodiode, photodetector, charge-coupled device, etc.), and/or the like. Input device(s) 506 may also include devices for reading and/or receiving removable storage devices or other removable media. Such removable media may include optical discs (e.g., Blu-ray discs, DVDs, CDs, etc.), memory cards (e.g., CompactFlash card, Secure Digital (SD) card, Memory Stick, etc.), floppy disks, Universal Serial Bus (USB) flash drives, external hard disk drives (HDDs) or solid-state drives (SSDs), and/or the like.

Output device(s) 508 may include one or more of various devices that convert information into human-readable form, such as without limitation a display device, a speaker, a printer, and/or the like. Output device(s) 508 may also include devices for writing to removable storage devices or other removable media, such as those described in reference to input device(s) 506. Output device(s) 508 may also include various actuators for causing physical movement of one or more components. Such actuators may be hydraulic, pneumatic, electric, etc., and may be provided with control signals by computer system 500.

Communications subsystem 510 may include hardware components for connecting computer system 500 to systems or devices that are located external computer system 500, such as over a computer network. In various embodiments, communications subsystem 510 may include a wired communication device coupled to one or more input/output ports (e.g., a universal asynchronous receiver-transmitter (UART), etc.), an optical communication device (e.g., an optical modem, etc.), an infrared communication device, a radio communication device (e.g., a wireless network interface controller, a BLUETOOTH® device, an IEEE 802.11 device, a Wi-Fi device, a Wi-Max device, a cellular device, etc.), among other possibilities.

Memory device(s) 512 may include the various data storage devices of computer system 500. For example, memory device(s) 512 may include various types of computer memory with various response times and capacities, from faster response times and lower capacity memory, such as processor registers and caches (e.g., L0, L1, L2, etc.), to medium response time and medium capacity memory, such as random access memory, to lower response times and lower capacity memory, such as solid state drives and hard drive disks. While processor(s) 504 and memory device(s) 512 are illustrated as being separate elements, it should be understood that processor(s) 504 may include varying levels of on-processor memory such as processor registers and caches that may be utilized by a single processor or shared between multiple processors.

Memory device(s) 512 may include main memory 514, which may be directly accessible by processor(s) 504 via the memory bus of communication medium 502. For example, processor(s) 504 may continuously read and execute instructions stored in main memory 514. As such, various software elements may be loaded into main memory 514 to be read and executed by processor(s) 504 as illustrated in FIG. 5. Typically, main memory 514 is volatile memory, which loses all data when power is turned off and accordingly needs power to preserve stored data. Main memory 514 may further include a small portion of non-volatile memory containing software (e.g., firmware, such as BIOS) that is used for reading other software stored in memory device(s) 512 into main memory 514. In some embodiments, the volatile memory of main memory 514 is implemented as random-access memory (RAM), such as dynamic RAM (DRAM), and the non-volatile memory of main memory 514 is implemented as read-only memory (ROM), such as flash memory, erasable programmable read-only memory (EPROM), or electrically erasable programmable read-only memory (EEPROM).

Computer system 500 may include software elements, shown as being currently located within main memory 514, which may include an operating system, device driver(s), firmware, compilers, and/or other code, such as one or more application programs, which may include computer programs provided by various embodiments of the present disclosure. Merely by way of example, one or more steps described with respect to any methods discussed above, might be implemented as instructions 516 executable by computer system 500. In one example, such instructions 516 may be received by computer system 500 using communications subsystem 510 (e.g., via a wireless or wired signal carrying instructions 516), carried by communication medium 502 to memory device(s) 512, stored within memory device(s) 512, read into main memory 514, and executed by processor(s) 504 to perform one or more steps of the described methods. In another example, instructions 516 may be received by computer system 500 using input device(s) 506 (e.g., via a reader for removable media), carried by communication medium 502 to memory device(s) 512, stored within memory device(s) 512, read into main memory 514, and executed by processor(s) 504 to perform one or more steps of the described methods.

In some embodiments of the present disclosure, instructions 516 are stored on a computer-readable storage medium, or simply computer-readable medium. Such a computer-readable medium may be non-transitory, and may therefore be referred to as a non-transitory computer-readable medium. In some cases, the non-transitory computer-readable medium may be incorporated within computer system 500. For example, the non-transitory computer-readable medium may be one of memory device(s) 512, as shown in FIG. 5 with instructions 516 being stored within memory device(s) 512. In some cases, the non-transitory computer-readable medium may be separate from computer system 500. In one example, the non-transitory computer-readable medium may a removable media provided to input device(s) 506, such as those described in reference to input device(s) 506, as shown in FIG. 5 with instructions 516 being provided to input device(s) 506. In another example, the non-transitory computer-readable medium may a component of a remote electronic device, such as a mobile phone, that may wirelessly transmit a data signal carrying instructions 516 to computer system 500 using communications subsystem 516, as shown in FIG. 5 with instructions 516 being provided to communications subsystem 510.

Instructions 516 may take any suitable form to be read and/or executed by computer system 500. For example, instructions 516 may be source code (written in a human-readable programming language such as Java, C, C++, C #, Python, etc.), object code, assembly language, machine code, microcode, executable code, and/or the like. In one example, instructions 516 are provided to computer system 500 in the form of source code, and a compiler is used to translate instructions 516 from source code to machine code, which may then be read into main memory 514 for execution by processor(s) 504. As another example, instructions 516 are provided to computer system 500 in the form of an executable file with machine code that may immediately be read into main memory 514 for execution by processor(s) 504. In various examples, instructions 516 may be provided to computer system 500 in encrypted or unencrypted form, compressed or uncompressed form, as an installation package or an initialization for a broader software deployment, among other possibilities.

In one aspect of the present disclosure, a system (e.g., computer system 500) is provided to perform methods in accordance with various embodiments of the present disclosure. For example, some embodiments may include a system comprising one or more processors (e.g., processor(s) 504) that are communicatively coupled to a non-transitory computer-readable medium (e.g., memory device(s) 512 or main memory 514). The non-transitory computer-readable medium may have instructions (e.g., instructions 516) stored therein that, when executed by the one or more processors, cause the one or more processors to perform the methods described in the various embodiments.

In another aspect of the present disclosure, a computer-program product that includes instructions (e.g., instructions 516) is provided to perform methods in accordance with various embodiments of the present disclosure. The computer-program product may be tangibly embodied in a non-transitory computer-readable medium (e.g., memory device(s) 512 or main memory 514). The instructions may be configured to cause one or more processors (e.g., processor(s) 504) to perform the methods described in the various embodiments.

In another aspect of the present disclosure, a non-transitory computer-readable medium (e.g., memory device(s) 512 or main memory 514) is provided. The non-transitory computer-readable medium may have instructions (e.g., instructions 516) stored therein that, when executed by one or more processors (e.g., processor(s) 504), cause the one or more processors to perform the methods described in the various embodiments.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes reference to one or more of such users, and reference to “a processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A cover apparatus operable to at least partially cover an appliance, the cover apparatus comprising:
a front side;
a left side coupled to the front side;
a right side coupled to the front side, wherein the front side, the left side, and the right side at least partially form an enclosure; and
one or more actuators operable to be mounted to a fixture situated above the appliance, wherein the one or more actuators are coupled to an underneath surface of the front side via one or more connectors that extend between the one or more actuators and the underneath surface of the front side;
wherein the cover apparatus is operable to move between an open position and a closed position, and wherein the appliance at least partially occupies the enclosure when the cover apparatus is in the closed position.

2. The cover apparatus of claim 1, further comprising:
a left pivot member coupled to a left surface of the fixture and to the left side; and
a right pivot member coupled to a right surface of the fixture and to the right side.

3. The cover apparatus of claim 2, wherein the left pivot member and the right pivot member form a pivot point for moving the cover apparatus.

4. The cover apparatus of claim 1, wherein the one or more actuators include a left actuator and a right actuator.

5. The cover apparatus of claim 1, wherein the one or more actuators are electrically powered and are operable to produce mechanical movement of the one or more connectors causing the cover apparatus to move between the open position and the closed position.

6. The cover apparatus of claim 1, wherein the appliance is accessible when the cover apparatus is in the open position.

7. The cover apparatus of claim 1, wherein the left side is at least partially parallel to the right side.

8. The cover apparatus of claim 7, wherein the front side is at least partially perpendicular to each of the left side and the front side.

9. The cover apparatus of claim 1, wherein the appliance is a microwave oven.

10. An apparatus operable to at least partially cover an appliance, the apparatus comprising:
a fixture having a front surface and a bottom surface, wherein the fixture is operable to be situated above the appliance, and wherein the bottom surface is operable to be coupled to the appliance; and
a cover apparatus comprising:
a front side;
a left side coupled to the front side;
a right side coupled to the front side, wherein the front side, the left side, and the right side at least partially form an enclosure; and
one or more actuators operable to be mounted to the fixture, wherein the one or more actuators are coupled to an underneath surface of the front side via one or more connectors that extend between the one or more actuators and the underneath surface of the front side;
wherein the cover apparatus is operable to move between an open position and a closed position, and wherein the appliance at least partially occupies the enclosure when the cover apparatus is in the closed position.

11. The apparatus of claim 10, wherein the cover apparatus further comprises:
a left pivot member coupled to a left surface of the fixture and to the left side; and
a right pivot member coupled to a right surface of the fixture and to the right side.

12. The cover apparatus of claim 11, wherein the left pivot member and the right pivot member form a pivot point for moving the cover apparatus.

13. The cover apparatus of claim 10, wherein the one or more actuators include a left actuator and a right actuator.

14. The cover apparatus of claim 10, wherein the one or more actuators are electrically powered and are operable to produce mechanical movement of the one or more connectors causing the cover apparatus to move between the open position and the closed position.

15. The cover apparatus of claim 10, wherein the appliance is accessible when the cover apparatus is in the open position.

16. The cover apparatus of claim 10, wherein the left side is at least partially parallel to the right side.

17. The cover apparatus of claim 16, wherein the front side is at least partially perpendicular to each of the left side and the front side.

18. The cover apparatus of claim 10, wherein the appliance is a microwave oven.
